(19) United States
(12) Patent Application Publication
(10) Pub. No.: US 2012/0198844 A1
(43) Pub. Date: Aug. 9, 2012

(54) System and Method For Producing Geothermal Energy

(76) Inventor: Robert D. Kaminsky, Houston, TX (US)

(21) Appl. No.: 13/395,385

(22) PCT Filed: Aug. 30, 2010
(86) PCT No.: PCT/US10/47160

§ 371 Date: Mar. 9, 2012

Related U.S. Application Data
(60) Provisional application No. 61/254,076, filed on Oct. 22, 2009.

(51) Int. Cl. F03G 4/06; F24J 3/08

(52) U.S. Cl. 60/641.5; 165/45

(57) ABSTRACT

The present techniques provide methods and systems for producing geothermal energy. The techniques include extracting geothermal energy from regions in a reservoir so as to reduce the stress in proximate regions. The geothermal energy is extracted from the proximate regions, and the extraction of geothermal energy is staged across subsequent regions in the reservoir.

### CROSS-REFERENCE TO RELATED APPLICATION

This application claims the benefit of U.S. Provisional Patent Application 61/254,076 filed 22 Oct. 2009 entitled SYSTEM AND METHOD FOR PRODUCING GEOTHERMAL ENERGY, the entirety of which is incorporated by reference herein.

### FIELD

Exemplary embodiments of the present techniques relate to a system and method for improved geothermal heat extraction from fractured rock.

### BACKGROUND

Current energy sources may have limitations in supply or possible environmental effects that have led to research efforts to identify alternate energy sources. For example, the combustion of hydrocarbons generates carbon dioxide. Other energy sources, such as wind and solar energy, are intermittent.

Another source of energy that can be considered is geothermal. Currently, a number of installations around the world use the energy from natural hot water or steam produced from subsurface formations to run turbines or heat facilities. However, energy from these natural hydrothermal formations can be limited by the geographic and geologic availability of such formations. In contrast, so-called “hot dry rock” formations underlie many regions of the world and contain substantial heat energy. These formations may be difficult to access due to their depth, which may be about two to ten kilometers, or more, below the surface of the Earth.

Heat may be extracted from a hot dry rock formation by injecting a fluid (typically water or brine) into the rock formation using injection wells, flowing the fluid through a network of fractures within the rock formation to absorb heat from the rock, and producing a heated fluid through production wells. Such a process is referred to as “hot dry rock” (HDR) geothermal energy extraction. The geothermally heated fluid that is produced may be used to directly heat industrial processes or may be used in conjunction with a thermodynamic cycle to generate power or electricity. In certain applications, a fracture network within the formation is stimulated to improve fluid transmissibility through the fractures. Stimulation may involve hydraulic fracturing, injection of proppants, pressurization to cause fracture slippage, or chemical treatments to cause solids dissolution and widen fractures. Systems which are stimulated are referred to as “enhanced geothermal systems” or “engineered geothermal systems” (EGS).

Conventional hot dry rock geothermal production often utilizes continuous injection of water into wells with production at distant wells (for example, at a well spacing of 500-1000 m). Ideally, the fracture system within the subterranean rock will permit injected water to distribute fairly uniformly throughout the rock to extract geothermal heat. Many subterranean rocks formations (for example, granite basement rock) have extensive networks of natural fractures, although in certain cases the fractures need to be dilated or opened to allow commercially valuable flow rates and heat extraction performance.

The presence of an extensive fracture network improves the performance of HDR geothermal energy extraction. Thermal diffusion is a slow process and, thus, rock that is more than several meters away from fluid flow through a fracture will not have its heat extracted in a commercially acceptable timeframe. Moreover, any real network of fractures will be composed of fractures of differing widths which will affect the fluid flow. More specifically, fluid flow is prone to channel preferentially through the larger fractures within a rock section. When this occurs, only a small fraction of the heat in the target section is actually removed in a reasonable amount of time. Additionally, the fluids produced from the formation may quickly cool to non-economic levels as the rock adjacent to the primary flow fractures are drained of their heat. Hence, using conventional HDR geothermal energy extraction methods, only a fraction of hot subterranean rock is likely to have suitable fracture networks to permit economic energy extraction.

U.S. Pat. No. 4,074,754 describes a method for producing geothermal energy from a subterranean high temperature reservoir by injecting low salinity water at ambient surface temperature, allowing the injected water to become heated in the reservoir, and then producing water through a well to be used as a source of energy. The method describes a staged well development plan for geothermal extraction. The staged plan utilizes cyclic injection and production through the same well for geothermal energy extraction. In one embodiment the method involves first, second, and third rows of wells drilled into the reservoir; and conducting injection-production cycles in each well of said first row of wells; shutting in each of the first row of wells; conducting injection-production cycles in each well of the second row of wells; conducting injection-production cycles in each well of the third row of wells; and then conducting injection in each well of the second row of wells while producing from each well of said first row of wells and third row of wells. The patent indicates that injection of cold water reduces the temperature of the reservoir around the injection wells and the invention permits reheating of that reservoir volume by overinjecting in selected wells to displace reservoir heat back to the vicinity of cold wells.

U.S. Pat. No. 4,220,205 describes a method of producing self-propping fluid-conductive fractures in rock. The method comprises pressurizing a subsurface formation and causing opposing faces of fractures to shear displace. After the shear displacement, the fractures are held open by the misfit between the opposing faces. The tendency for fracture faces to shear displace arises from shear stress retained from the original formation of the fractures.

Early descriptions of hot dry rock geothermal energy extraction were provided in U.S. Pat. Nos. 3,786,858 and 3,817,038. U.S. Pat. No. 3,786,858 describes extracting energy from a dry igneous rock geothermal reservoir by a method that includes drilling a well in hot igneous rock to reach at least 150° C., hydraulically fracturing the rock, and circulating water through the crack system. U.S. Pat. No. 3,817,038 describes a method of heating an aqueous fluid in a dry geothermal reservoir formation penetrated by an injection well and a production well, forcing the fluid into the formation with simultaneous heating, and recovering the heated fluid via the production well.

U.S. Patent Application Publication No. 2006/0201674 describes a method for treating subterranean formations using low-temperature fluids. For example, an embodiment of the method involves treating a subterranean, hydrocarbon-bearing formation by placing a low-temperature fluid in the subterranean formation so as to create or enhance at least one fracture therein, the low-temperature fluid having a temperature below the ambient temperature at the surface. The thermally initiated fractures occur at lower pressure then other pressure fractures, but at pressures that are often higher than the formation pressure. The fractures may be propped open by the addition of proppants.

Having a network of fractures which are highly permeable and well-connected throughout the targeted hot rock is important for the economic production of “hot dry rock” geothermal energy. More specifically, permeable, well-connected fracture networks allow heat to be efficiently recovered by fluid flow through a large bulk of rock. However, natural fracture networks can vary greatly in local permeability, even if stimulated using high pressure fluid injection to place proppants or force shear displacement between fracture faces. Further, stimulation methods tend to be most effective near wellbores used for fluid injection and are their impact is much less uniform away from the wellbores. Thus, new techniques for opening fractures in geothermal reservoirs would be beneficial.

### SUMMARY

An exemplary embodiment of the present techniques provides a method for producing geothermal energy. The method includes extracting geothermal energy from regions in a reservoir so as to reduce the stress in proximate regions; extracting geothermal energy from the proximate regions; and staging the extraction of geothermal energy across the regions in the reservoir.

The geothermal energy may be extracted by injecting water into a region to be heated and producing the heated water. The reservoir may be a layer of hot dry rock. The heat may be extracted from the region until a rock temperature adjacent a producer well within the region drops by at least 5° C. below an initial rock temperature.

At least one injection well and at least one production well may be drilled to each region. At least one injection well and at least one production well may be extended to harvest energy from a deeper region. Perforations may be created in at least one injection well and at least one production well, wherein the perforations are above a currently produced region and wherein the perforations allow the harvesting of geothermal energy from a shallower region. In an exemplary embodiment injection is ceased in earlier extracted regions after injection is started in subsequently extracted regions.

Electric power may be generated using a geothermally heated fluid from the reservoir. The electric power may be generated by flashing the geothermally heated fluid into a vapor and driving a turbine from the vapor. In another exemplary embodiment the vapor from the turbine may be captured and passed through a heat exchange to heat a second fluid, flashing the second fluid into a second vapor. The second vapor may be used to drive a second turbine.

In another exemplary embodiment, the geothermally heated fluid may be passed through a heat exchanger to heat a second fluid, flashing the second fluid into a vapor. The vapor may then be used to drive a turbine. Other processed may be heated using a geothermally heated fluid from the reservoir.

Another exemplary embodiment of the present techniques provides a system for extracting geothermal energy from a fractured subsurface formation. The system includes a geothermal reservoir, wherein the geothermal reservoir is subdivided into a plurality of different regions and a production system configured to inject a fluid into each of the regions and produce a geothermally heated fluid from each of the regions. The extraction of heat may be staged across each of the plurality regions to decrease stress on subsequent regions prior to starting production of geothermal from the subsequent regions. A heat exchanger system may be configured to remove the heat energy from the geothermally heated fluid. The system may also include rows of injector wells and producer wells which are aligned with a major fracture direction in the geothermal reservoir.

In an exemplary embodiment of the system, a turbine can be configured to be powered by an expanding vapor and a generator can be configured to be driven by the turbine. A flash unit may be included to allow the substantially uniform flow to flash into a vapor and a turbine configured to be driven by the vapor from the flash unit. The system can also an operating fluid configured to remove heat from the heat exchanger and a flash vessel configured to allow the operating fluid to flash into a vapor. A turbine can be driven by the vapor. In another exemplary embodiment, a process plant can be configured to be powered at least in part from heat energy. In other embodiments, an electrical generator configured to be powered by mechanical energy provided from a turbine.

### DESCRIPTION OF THE DRAWINGS

The advantages of the present techniques are better understood by referring to the following detailed description and the attached drawings, in which:

FIG. 1a is a schematic view of a geothermal energy production system, in accordance with an exemplary embodiment of the present techniques;

FIG. 1b is a schematic view of an exemplary generation system that may be used with the geothermal energy production system of FIG. 1a, in accordance with an embodiment of the present techniques;

FIG. 2 is a top view of a grid of injection and production wells that are used in the staged production of geothermal energy from a first region in a reservoir, in accordance with an exemplary embodiment of the present techniques;

FIG. 3 is a top view of a grid of injection and production wells that are used in the staged production of geothermal energy from the second regions in the reservoir, in accordance with an exemplary embodiment of the present techniques;

FIG. 4 is a top view of a grid of injection and production wells that are used in the staged production of geothermal energy from the third regions in the reservoir, in accordance with an exemplary embodiment of the present techniques; and

FIG. 5 is method for harvesting geothermal energy from rock formations using staged production of regions to release stress in subsequent regions, in accordance with an exemplary embodiment of the present techniques.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Boundaries” refer to locations of changes in the properties of subsurface rocks, which typically occur between geologic formations. This is relevant, for example, to the thickness of formations.

A “compressor” is a machine that increases the pressure of a gas by the application of work (compression). Accordingly, a low pressure gas (for example, 5 psig) may be compressed into a high-pressure gas (for example, 1000 psig) for transmission through a pipeline, injection into a well, or other processes.

“Directional drilling” is the intentional deviation of the wellbore from the path it would naturally take. In other words, directional drilling is the steering of the drill string so that it travels in a desired direction. Directional drilling can be used for steering a production well into a fracture cloud around an injection well in a rock formation, as discussed below.

“Exemplary” is used exclusively herein to mean “serving as an example, instance, or illustration.” Any embodiment described herein as “exemplary” is not to be construed as preferred or advantageous over other embodiments.

A “facility” is a representation of a tangible piece of physical equipment through which fluids are either produced from a reservoir or injected into a reservoir. In its broadest sense, the term facility is applied to any equipment that may be present along the flow path between a reservoir and its delivery outlets, which are the locations at which fluids either enter the reservoir (injected fluids) or leave the reservoir (produced fluids).

A “formation” is any finite subsurface region. The formation may contain one or more hot dry rock layers, an overburden, or an underburden. An “overburden” or an “underburden” is geological material above or below the formation of interest. For example, overburden or underburden may include rock, shale, mudstone, or other types of sedimentary, igneous or metamorphic rocks.

A “fracture” is a crack or surface of breakage within rock not related to foliation or cleavage in metamorphic rock along which there has been no movement. A fracture along which there has been displacement is a fault. When walls of a fracture have moved only normal to each other, the fracture is called a joint. Fractures may enhance permeability of rocks greatly by connecting pores together, and for that reason, fractures are induced mechanically in some reservoirs in order to boost fluid flow.

“Fracturing” is a term used to describe a number of techniques for creating and/or opening fractures that extend from the well bore into formations. In hydraulic fracturing, a fracturing fluid, typically viscous, is injected into the formation with sufficient hydraulic pressure (for example, at a pressure greater than the lithostatic pressure of the formation) to create and extend fractures, open pre-existing natural fractures, or cause slippage of faults. In the formations discussed herein, natural fractures and faults may be opened by the pressure. A proppant may then be used to “prop” or hold open the fractures after the hydraulic pressure has been released. The fractures may be useful for allowing fluid flow, for example, through a geothermal energy source, such as a hot dry rock layer. The fractures tend to be vertical at the depths used for geothermal energy production, due to the increased pressure of the overburden.

“Geological layers” or “layers” refers to layers of the subsurface (for example, the Earth's subsurface) that are disposed between geologic formation tops. A geological layer may include a hot dry rock formation or may represent subsurface layers over a hot dry rock layer.

A “hot dry rock” layer is a layer of rock that has a substantial temperature differential with the surface, for example, 50° C., 100° C., 200° C., or even greater. The hot dry rock layer may be a granite basement rock around two to 20 Km, or even greater, below the surface of the Earth. As described herein, the heat in the hot dry rock layer may be harvested for energy production. Despite the name, “hot dry rock” is not necessarily devoid of water. Rather, such layers of rock will not naturally produce significant amounts of water or steam flows to the surface without the aid of pumps or fluid injection.

A “horizontal well bore” is used herein to mean the portion of a well bore in an subterranean region to be completed which is substantially horizontal or at an angle from horizontal in the range of from about 0° to about 15°.

“Lithostatic pressure” (sometimes referred to as “lithostatic stress”) is a pressure in a formation equal to a weight per unit area of an overlying rock mass (the “overburden”). The pressure in the formation is around 1 psi for every foot of depth. Thus, a formation that is 100 feet deep may have a fluid pressure of 100 psig. This concept is also related to hydraulic fracturing, as a formation that is at a particular fluid pressure will not fracture until that pressure is exceeded. For example, a formation at a depth of 3000 ft below the surface may require a pressure of greater than about 3000 psig to fracture.

“Perforated” means that the member or liner has holes or openings (“perforations”) through it. The holes can have any shape, for example, round, rectangular, slotted or the like. The term is not intended to limit the manner in which the holes are made, i.e., it does not require that they be made by perforating, or the arrangement of the holes. A perforated well may be used to inject or collect fluids from a reservoir, such as a fracture cloud in a hot dry rock layer.

“Permeability” indicates an apparent Darcy permeability reflecting a fluid flow caused by a pressure difference across a distance greater than an average spacing of natural fractures in the section, wherein the apparent permeability is calculated by applying Darcy's Law.

“Pressure” is the force exerted per unit area by a fluid on the walls of a volume. Pressure may be presented as pounds per square inch (psi). “Atmospheric pressure” refers to the local pressure of the air. Local atmospheric pressure is assumed to be 14.7 psia, the standard atmospheric pressure at sea level. “Absolute pressure” (psia) refers to the sum of the atmospheric pressure plus the gage pressure (psig). “Gage pressure” (psig) refers to the pressure measured by a gauge, which indicates only the pressure exceeding the local atmospheric pressure (i.e., a gauge pressure of 0 psig corresponds to an absolute pressure of 14.7 psia). The term “vapor pressure” has the usual thermodynamic meaning. For a pure component in an enclosed system at a given pressure, the component vapor pressure is essentially equal to the total pressure in the system.

“Produced fluids” and “production fluids” refer to liquids or gases removed from a subsurface formation. Produced fluids may include liquids, such as water heated by a HDR formation, or gases, such as steam.

“Steam” refers to water vapor or a combination of liquid water and water vapor. If the steam is superheated, it may contain minimal amounts of liquid water and may be termed dry steam. Steam that is in direct contact with liquid water, such as condensate, is termed saturated steam. It will be understood by those skilled in the art that steam may additionally contain trace elements, gases other than water vapor or other impurities. For example, steam produced from a hot dry rock layer may have some amounts of hydrogen sulfide, carbon dioxide, or other materials extracted from the rock.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

“Thickness” of a layer refers to the distance between the upper and lower boundaries of a cross section of a layer, wherein the distance is measured normal to the average tilt of the cross section.

“Utilities” means (unless otherwise specified) anything consumed in a facility or process unit including any fluid (gas or liquid) used to operate the equipment of the facility or process unit. Some common examples of utilities can include electrical power, fuel gas, seal gas, instrument and control gas, nitrogen or inert gas, blanket gas, hydraulic fluids, pneumatic systems, water (including non-potable water), diesel or gasoline to run turbines or boilers or any other fluid or energy input used to run the equipment for a given process (for example, mechanical energy used to run a compressor).

“Well” or “wellbore” refers to a hole in the subsurface made by drilling or insertion of a conduit into the subsurface. The terms are interchangeable when referring to an opening in the formation. A well may have a substantially circular cross section, or other cross-sectional shapes (for example, circles, ovals, squares, rectangles, triangles, slits, or other regular or irregular shapes). Wells may be cased, cased and cemented, or open-hole well, and may be any type, including, but not limited to a producing well, an experimental well, an exploratory well, or the like. A well may be vertical, horizontal, or any angle between vertical and horizontal (a deviated well), for example a vertical well may comprise a non-vertical component.

“Wellhead” consists of the pieces of equipment mounted at the opening of a well, for example, to regulate and monitor the production fluids from the underground formation. It may also prevent leaking of production fluids out of the well and/or blowouts due to high pressures fluids from formations. Formations that generate high temperature fluids, such as superheated water or steam, are under high pressure and typically require wellheads that can withstand a great deal of upward pressure from the escaping gases and liquids. These wellheads may often be designed to withstand pressures of up to 20,000 psi (pounds per square inch). The wellhead consists of three components: the casing head, the tubing head, and the ‘Christmas tree’. The casing head consists of heavy fittings that provide a seal between the casing and the surface. The casing head also serves to support the length of casing that is run down the well. This piece of equipment typically contains a gripping mechanism that ensures a tight seal between the head and the casing itself.

Exemplary embodiments of the present techniques provide methods and systems for extracting geothermal heat from neighboring regions in a fractured rock formation. The techniques utilize the cooling of a region that occurs during the production of geothermal energy from within a hot subsurface rock formation to cause stress relaxation in proximate regions, which are subsequently produced. The stress relaxation occurs due to thermal contraction of a rock region as it is cooled which in turn allows neighboring regions to slightly expand (or relax) and further open up fractures within those regions. The rock formation typically has natural fractures, although permeability may have been enhanced by artificial stimulation. An exemplary embodiment of the present techniques helps ensure heat is extracted from the whole rock volume by relaxing native stresses and promoting dilation of existing fractures within the rock. This dilation also increases permeability in the rock, which can make more locations suitable for geothermal extraction and speed the extraction of geothermal energy from hot rock.

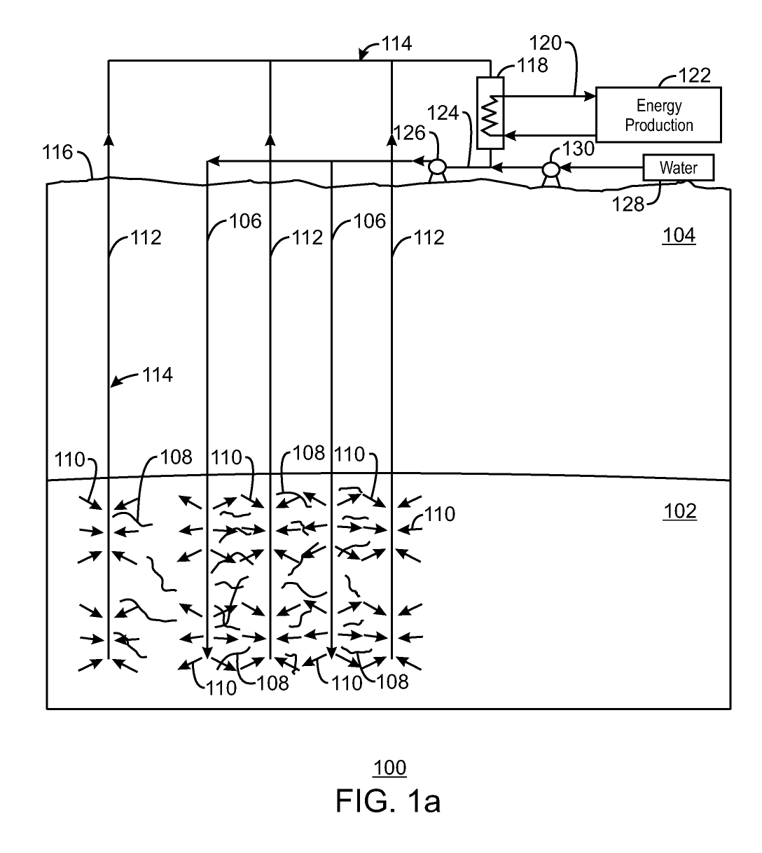

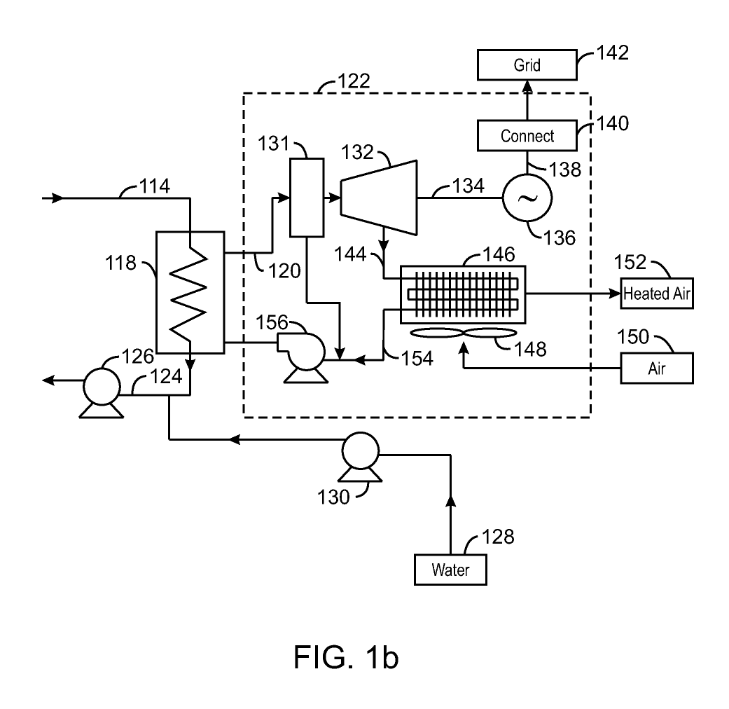

FIG. 1a is a schematic view of a geothermal energy production system, in accordance with an exemplary embodiment of the present techniques. As shown in FIG. 1a, the energy production system is generally referred to by the reference numeral 100. The energy production system 100 may be used to harvest heat energy from layers of hot dry rock (HDR) 102, such as Precambrian or Hadean Era crystalline rock, including granites, basalts, and the like. The targeted rock regions may be thick formations (for example, greater than about 300 meters).

Various layers of sedimentary, igneous, or metamorphic rock may form an overburden 104 above the HDR 102. Injection wells 106 may be drilled through the overburden 104 and into the HDR 102 for the injection of fluids used to harvest the heat energy contained in the HDR 102. There will often be more than one injection well 106, since it may be problematic to pressurize a sizeable rock section that is not surrounded by injection wells 106. Thus, the system will often have a pattern of injection and production wells that includes two or more injection wells with at least one production well located within a perimeter defined by the injection wells.

The fluid injected into the HDR 102 may include water or various other fluids, such as supercritical CO₂. The fluid may travel through fractures 108 in the HDR 102, as indicated by the arrows 110. The fractures 108 may be natural, although they may be opened or enhanced by various techniques. Such techniques may include, for example, hydraulically fracturing, with or without the addition of proppants, or by pressurizing the HDR 102 to cause slippage and geometric mismatch of fracture surfaces. In exemplary embodiments of the present techniques, the fractures 108 may be opened or enhanced by the cooling of proximate regions, which may relieve pressure on the region being produced, allowing the fractures to open.

Production wells 112 collect the geothermally heated fluid 114 and return it to the surface 116 for processing. In an exemplary embodiment, the geothermally heated fluid 114 can be passed through a heat exchanger 118, which may be used to heat a secondary fluid 120 for energy production 122 (for example, using the system discussed with respect to FIG. 1b). The heat exchanger 118 may be a typical tube shell design, or any other design that may be used to transfer heat from the geothermally heated fluid 114 to the secondary fluid 120. After the geothermally heated fluid 122 passes through the heat exchanger 118, the cooled fluid 124 may be passed through an injection pump 126 for injection back into the HDR 102 through the injections wells 106. A fluid makeup, for example, water 128, may be added to the cooled fluid 124 through a makeup pump 130 to make up for fluid lost in the formation or the cooling loop. In another exemplary embodiment, the geothermally heated fluid is flashed into a vapor, for example, in a flash vessel, and the vapor is used to drive a turbine for energy generation. In yet other embodiments, the geothermally heated fluid may be used to directly or indirectly heat a process.

In certain embodiments, fluid injection into a well may be fairly continuous, whereas in other embodiments fluid injection into a well may be cyclic in nature. Likewise, in certain embodiments, fluid production from a well may be fairly continuous, whereas in other embodiments fluid production from a well may be cyclic in nature.

FIG. 1b is a schematic view of an energy production system that may be used with the geothermal energy production system of FIG. 1a, in accordance with an embodiment of the present techniques. The energy production system is generally referred to by the number 122. As would be understood, this is merely one example of any number of systems that could be used to generate or transfer energy from the geothermally heated fluid 114. As shown in this exemplary embodiment, the heated secondary fluid 120 may be flashed into a vapor, for example, in a flash vessel 131, and used to drive a turbine 132. Mechanical power may be transferred from the turbine 132 through a shaft 134 to an electrical generator 136. Electrical power 138 from the generator 136 may be fed through an interconnect 140 to an electrical grid 142. The low pressure vapor 144 from the turbine may be passed through a secondary heat exchanger 146 for cooling and condensation. A fan 148 may pass air 150 over the secondary heat exchanger 146, removing heat from the low pressure vapor 144 into the heated air 152. After removal of the heat, the condensed fluid 154 may be pressurized, for example, by a pump 156, before being passed back through the heat exchanger 118. The secondary fluid may comprise water, ammonia, propane, butane, pentane, a commercial refrigerant, or other fluid with a phase behavior to allow vaporizing and condensing at the available temperatures.

The energy production system 122 described above is based on a thermodynamic cycle and may be termed an organic Rankine cycle (ORC). However, energy production is not limited to an ORC as other cycles or systems may be used to harvest the energy, such as direct flash, a Kalina cycle, and numerous other systems. For example, in other exemplary embodiments, the geothermally heated fluid 114 may be directly flashed into a vapor and used to drive a turbine, for example, for the generation of electricity. Further, the geothermally heated fluid 114 may be used to provide heat to a process such as a thermal reforming process. In other embodiments, the heat exchanger 118 may be used to directly heat a gas, such as an airflow used for heating buildings or residences.

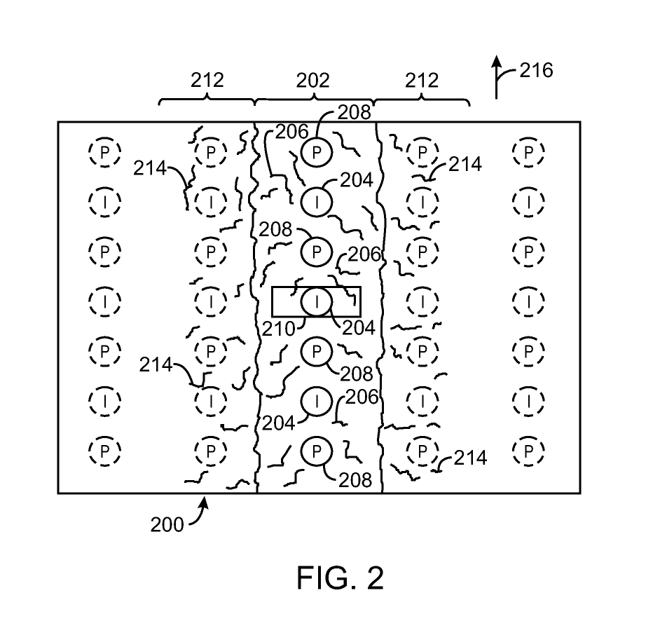

The geothermal energy may be produced using a number of injection and production wells, for example, arranged in a grid pattern over the reservoir. In exemplary embodiments, the wells may be separated into different regions, where each region has a number of injection and production wells that may be aligned along a major fracture direction, i.e., along the direction that a substantial proportion of the fractures are aligned. This is discussed further with respect to FIGS. 2-4.

FIG. 2 is a schematic view of a grid of injection and production wells that are used in the staged production of geothermal energy from a first region in a reservoir, showing production from a first region, in accordance with an exemplary embodiment of the present techniques. The reservoir is generally referred to by the number 200. As shown in FIG. 2, a first region 202 has a number of injection wells 204 for injecting a fluid into the reservoir 200. As discussed above, the fluid may flow through numerous natural and/or enhanced fractures 206 prior to being collected at production wells 208. One or more facilities at the surface, such as facility 210, may be operatively coupled to each of the wells 204 and 208, providing the fluid for injection and obtaining energy from the geothermally heated fluid collected.

As the geothermal energy is collected from the first region 202, the rock in the first region 202 cools. The cooling causes thermal contraction of the rock, which allows stress relaxation in neighboring second regions 212, for example, by allowing the rock in the second regions 212 to shift or expand into the previously contracted first region 202. This may lead to opening or widening of fractures 214 in the second region 212.

In an exemplary embodiment, the regions 202 and 212 are selected so as to be aligned along a major fracture direction 216, increasing the dilation of fractures 214 in the second regions 212. The direction 216 of major fractures can be determined by examining core samples or by mapping microseismic events, for example, during injection and/or fracturing. Aligning the injection and production wells 204 and 208 with the direction 216 of major fractures may also allow for increased flow of fluids during production of geothermal energy. In other embodiments, the first and second regions may comprise sets of wells arranged in patterns other than single rows. For example, wells may be arranged in rectangular, triangular, or hexagonal patterns.

Dilation of fractures 206 and 214 may occur after the first region 202 cools by about 10° C., 5° C., or even less. More specifically, granite may have a coefficient of thermal linear expansion of about 8.5×10⁻⁶ per degree Celsius. Therefore, a 1° C. lowering in temperature would cause a 0.00085% reduction in a linear dimension of a solid piece of granite.

The contraction of the rock will mostly be accommodated by widening of fractures 206 and 214 in the rock, which may comprise a small fraction of the total volume, such as about 0.1% or less. Assuming the fractures 206 and 214 comprise a volume fraction of about 0.1%, a 0.00085% linear reduction in the rock volume results in a 0.85% change in fracture gap width per 1° C. of cooling for fractures 206 and 214 that are perpendicular to the contraction direction. For example, 10° C. of cooling may result in as much as an about 8.5% increase in the average fracture gap size. In the case of laminar flow through a smooth narrow slit, the volumetric flow rate at a constant pressure gradient increases by the third-power of the width of the slit. Thus, an increase of 8.5% in a slit can result in an increase of about 28% in the volumetric flow rate.

The flow enhancement effect may be greater if the fractures 206 and 214 were essentially closed and are opened due to the stress relaxation. Moreover, the contraction may permit lateral shifting of the rock in the regions 202 and 212, for example, from the second regions 212 in the direction of the cooled first region 202. This shifting of the rock may further enhance flow through fractures 206 and 214. More specifically, the shifting of rock may allow fractures 206 and 214 to be propped open by a mismatch between opposite sides of a fracture. The temperature of the first region 202 may be monitored by tracking rock temperature adjacent to a well 204 or 208 within the producing region (such as the first region 202), downhole fluid temperature within a producing well 208, or fluid temperature at the surface from a producing well 208. Typically, temperature changes at a producing well 208 lag temperature changes within the region 202 since regions closest to injection wells 204 cool first. Thus a relatively small reduction in temperature near a producing well 208, or in the produced fluids, may represent a much larger average temperature change within the region 202.

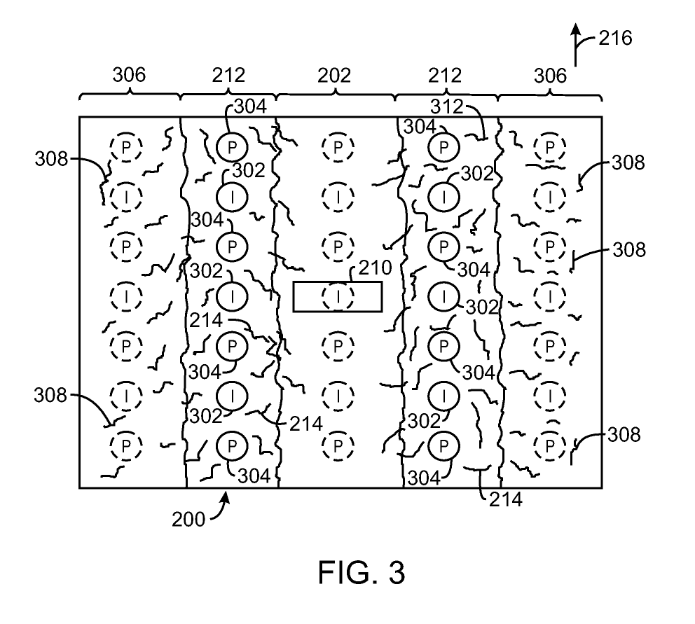

After the first region 202 has cooled to the point where further production is no longer economical (for example, by 5° C., 10° C., 20° C., or any other value based in part on the economics of the energy generation process), the injection and production wells 204 and 208 may be shut in, and production shifted to the second regions 212, which have undergone some dilation of fractures due to the cooling of region 202. This is discussed further with respect to FIG. 3.

FIG. 3 is a top view of a grid of injection and production wells that are used in the staged production of geothermal energy from the second regions in the reservoir, in accordance with an exemplary embodiment of the present techniques. As for the first region 202, a number of injection wells 302 are used to inject fluid into the second regions 212 of the reservoir 200. As discussed above, the fluid may flow through the fractures 214 in the second regions 212 prior to being collected at production wells 304. The facility 210 at the surface is operatively coupled to each of the wells 302 and 304, providing the fluid for injection and obtaining energy from the geothermally heated fluid collected.

As the geothermal energy is collected from the second regions 212, the rock in the second regions 212 cools. As for the first region 202, this cooling causes thermal contraction of the rock in the second regions 212, which allows stress relaxation in the neighboring third regions 306, for example, by allowing the rock in the third regions 306 to shift or expand into the cooling and contracting second regions 212. This may lead to opening or widening of fractures 308 in the third regions 306. As for the first region 202 and second regions 212, the third regions 306 may be selected so as to be aligned along a major fracture direction 216, increasing the dilation of fractures 308 in the third regions 306. Once the temperature of the second regions 212 has decreased to a point where harvesting the energy is no longer economical, the wells 302 and 304 in the second regions 212 may be shut in and production may be shifted to the third regions 306.

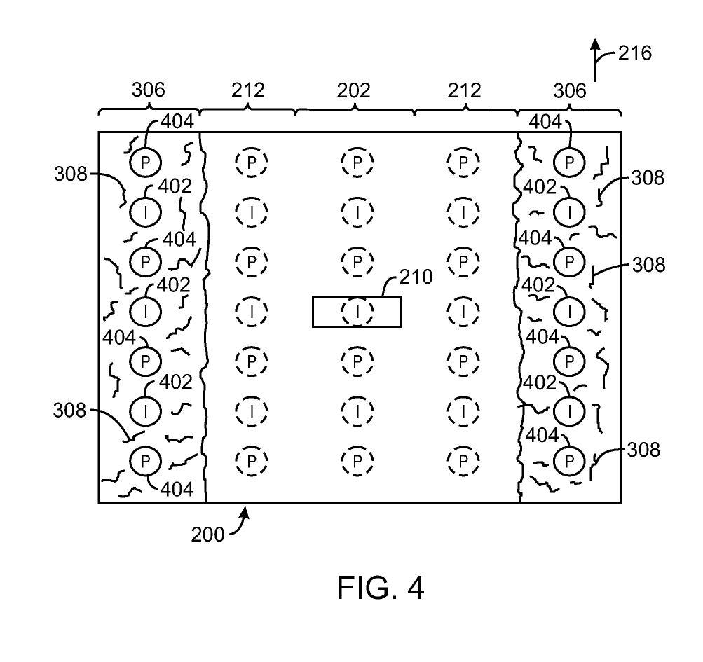

FIG. 4 is a top view of a grid of injection and production wells that are used in the staged production of geothermal energy from the third regions in the reservoir, in accordance with an exemplary embodiment of the present techniques. As for the first region 202 and second regions 212, a number of injection wells 402 may be used to inject fluid into the third regions 306 of the reservoir 200. As discussed above, the fluid may flow through the fractures 308 of the third region 306 prior to being collected by production wells 404. The facility 210 at the surface may be operatively coupled to each of the wells 402 and 404. However depending on well spacing, it may be advantageous to have more than one facility for injection and/or production. Thus some wells, for example wells 302, 304, 402, or 404 may be connected to a facility (not shown) other than 210.

The production of geothermal energy is not limited to the regions shown above. In other embodiments, the production may be staged across four, five, six, or more regions in the hot dry rock. Further, the number of wells is not limited to those shown in FIGS. 2-4, as any number of wells may be used to harvest energy from the reservoir. Moreover, the wells may be horizontal or deviated in nature and not only vertical as shown. Furthermore, the wells may be completed in (i.e., connected to) more than one target region. For example, injection and production wells may be extended to reach deeper regions after shallower regions have cooled. Further, wells to deep regions may have new perforations created to access regions located at shallower depths. This arrangement may take advantage of gravity to open fractures, as the cooling of deeper regions may allow shallower regions to partially collapse (or slump) into the contracted rock of the deeper region.

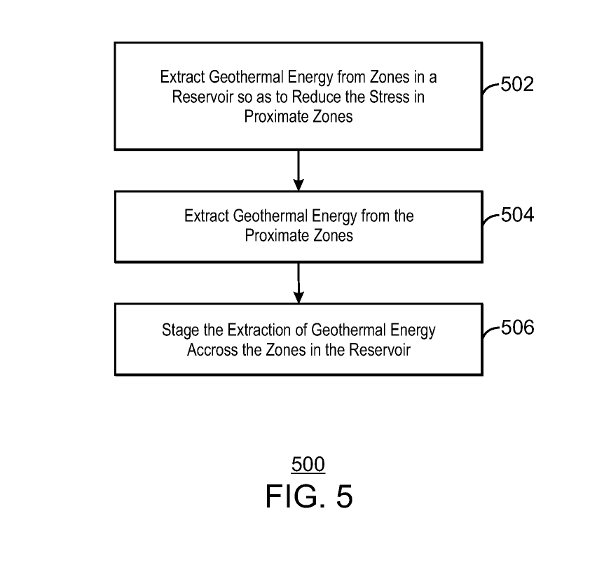

FIG. 5 is method for harvesting geothermal energy from rock formations using staged production of regions to release stress in subsequent regions, in accordance with an exemplary embodiment of the present techniques. The method is generally referred to by reference number 500. The method 500 begins at block 502 with the extraction of geothermal energy from one or more regions in a reservoir. The extraction of the energy reduces the stress in proximate regions, allowing fractures to open or expand in the proximate regions. Once the initial regions have cooled to a designated point (for example, where the production of the geothermal energy is no longer economical), production is shifted to the proximate regions, as indicated at block 504. This cooling may occur in a few years (for example, 1 year, 2 years, or 5 years), or may take a substantial period of time (such as 10 years, 20 years, or more). The production of energy from the proximate regions cools the proximate regions, relieving stress on further regions, and allowing fractures in the further regions to open or expand. Thus, as indicated at block 506, production of the geothermal energy is staged across the regions in the reservoir, relieving stress on subsequent regions as prior regions cool.

While the present techniques may be susceptible to various modifications and alternative forms, the exemplary embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A method for producing geothermal energy from a fractured rock reservoir, comprising:
extracting geothermal energy from a production region in a reservoir so as to reduce a stress in a proximate region;
extracting the geothermal energy from the proximate region; and
staging an extraction of the geothermal energy across two or more regions in the reservoir.

2. The method of claim 1, wherein the reservoir is a layer of hot dry rock.

3. The method of claim 1 wherein extracting the geothermal energy is performed by injecting water into the production region and producing heated water from the production region.

4. The method of claim 1, further comprising extracting the geothermal energy from the production region until a rock temperature adjacent a producer well within the production region drops by at least 5° C. below an initial rock temperature.

5. The method of claim 1, further comprising drilling at least one injection well and at least one production well to each of the two or more regions.

6. The method of claim 1, further comprising vertically extending an injection well and a production well below the production region to harvest energy from a deeper region.

7. The method of claim 1, further comprising creating perforations in an injection well and a production well, wherein the perforations are above the production region and wherein the perforations allow the harvesting of the geothermal energy from a shallower region.

8. The method of claim 1, wherein an injection is stopped in an earlier extracted region after injection is started in the proximate regions.

9. The method of claim 1, further comprising:
generating electric power using a geothermally heated fluid from the reservoir.

10. The method of claim 9, comprising:
flashing the geothermally heated fluid into a vapor; and
driving a turbine from the vapor.

11. The method of claim 10, comprising:
capturing the vapor from the turbine;
passing the vapor through a heat exchanger to heat a second fluid;
flashing the second fluid into a second vapor; and
driving a second turbine from the second vapor.

12. The method of claim 9, comprising:
passing the geothermally heated fluid through a heat exchanger to heat a second fluid;
flashing the second fluid into a vapor; and
driving a turbine from the vapor.

13. The method of claim 1, further comprising:
heating a process using a geothermally heated fluid from the reservoir.

14. A system for extracting geothermal energy from a fractured subsurface formation, comprising:
a geothermal reservoir, wherein the geothermal reservoir is subdivided into a plurality of regions;
a production system configured to inject a fluid into a one of the plurality of regions and produce a geothermally heated fluid from a one of the plurality of regions, wherein an extraction of heat from the one of the plurality of regions to decrease a stress on a subsequent region prior to starting production of the geothermally heated fluid from the subsequent region; and
an energy production system configured to remove heat energy from the geothermally heated fluid.

15. The system of claim 14, further comprising rows comprising injector wells and producer wells, wherein the rows are aligned with a major fracture direction in the geothermal reservoir.

16. The system of claim 14, further comprising:
a flash vessel configured to allow the geothermally heated fluid to flash into a vapor.

17. The system of claim 16, further comprising:
a turbine configured to be powered by the vapor; and
a generator configured to be driven by the turbine.

18. The system of claim 14, further comprising:
a heat exchanger configured to transfer the heat energy from the geothermally heated fluid to an operating fluid;
a flash vessel configured to allow the operating fluid to flash into a vapor; and
a turbine configured to be driven by the vapor.

19. The system of claim 14, wherein the energy production system comprises an electrical generator configured to be powered by mechanical energy provided from a turbine.

20. The system of claim 14, further comprising:
a process plant configured to be powered at least in part from the heat energy.
